(19) United States
(12) Patent Application Publication
(10) Pub. No.: US 2008/0209468 A1
(43) Pub. Date: Aug. 28, 2008

(54) Clock-Based User Interface for Audio/Video Play Lists Navigation/Editing

(75) Inventor: Vlatko Milosevski, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,110

(22) PCT Filed: Oct. 11, 2005
(86) PCT No.: PCT/IB05/53341

§ 371 Date: Apr. 12, 2007

Related U.S. Application Data
(60) Provisional application No. 60/618,424, filed on Oct. 13, 2004.

(51) Int. Cl. G11B 27/10

(52) U.S. Cl. 725/39

(57) ABSTRACT

An apparatus for navigating an area (218) of memory (142), such as a play list of recorded audio/video, includes a clock-face-based user interface (128) with superimposed, rotatable clock hands (132, 136, 404, 408). In one embodiment, items may be added to, or deleted from, the play list at the navigated-to location in the list (260). In another embodiment, a screen field (140) is updated in real time to indicate the item currently being played back (204), or during navigation, the item currently navigated to (260).

The present invention relates to a clock-face-based user interface and, more particularly, to clock- ace-based user interface for navigating memory.

A play list is a list of pre-selected audio and/or video files that have been saved for playback, as a unit, in their sequential order. The play list can be built up by the-user who selects the files or “programs” for deferred playback, the play list being saved on a hard disk drive (HDD) of a video recorder or in flash memory. The selection might be performed through a user interface to a time-shift buffer which contains, in time order, recordings of programs received over the air from a broadcasting station or video-on-demand provider. An exemplary user interface is disclosed in a co-pending, commonly-owned, provisional U.S. application by the present inventor, entitled “Clock-Based User Interface for HDD Time-Shift Buffer Navigation,” disclosure ID 695571. Alternatively, the user may obtain the play list as a package, as through downloading from a network or other source. In either event, the play list is saved, to be subsequently played back as a unit upon the user's command.

Due to the potential length of a play list and the growing demand for smaller displays, it is desirable to implement a simple, intuitive and compact user interface through which the ordinary user can immediately understand, navigate and edit play lists.

In one aspect, the present invention provides an apparatus, a method operable on the device, and a computer program for performing the method, wherein the apparatus is operable to navigate an area of memory. The apparatus includes a user input device, a processor, and a clock face sectorized into time intervals. In response to user input from the input device, a clock hand is rotated around the clock face to navigate the area of memory, contents of the area corresponding with the sectors.

In another aspect, the navigating is operable and responsive to user input from the input device, for navigating the area to add to and/or delete contents of the area of memory.

In yet another aspect, the present invention provides a display for displaying a field and a clock face sectorized into time intervals. Responsive to user input from a user input device, a clock hand is rotated across the face concentrically with the sectors. Items are displayed in the field in correspondence with the sector currently containing the clock hand.

Details of the invention disclosed herein shall be described with the aid of the figures listed below, wherein:

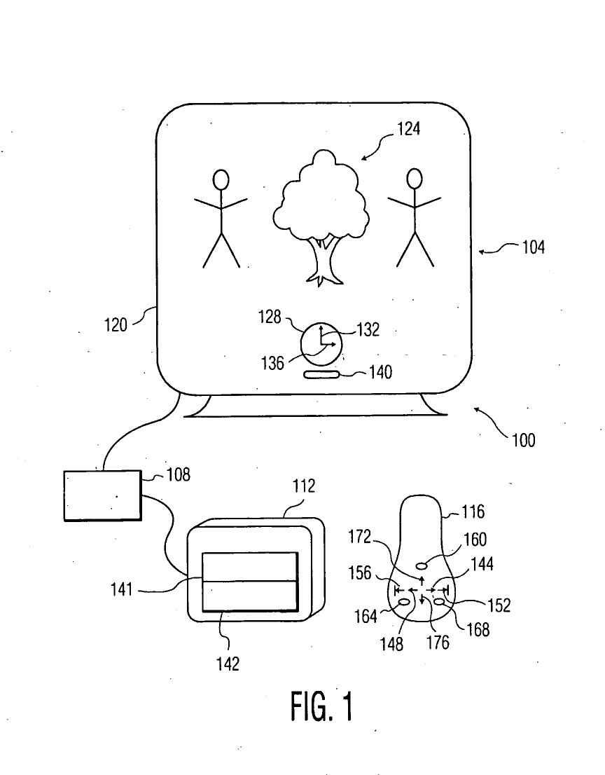

FIG. 1 is a depiction of a PVR system having a user interface for clock-face-based play-list navigation and editing in accordance with the present invention;

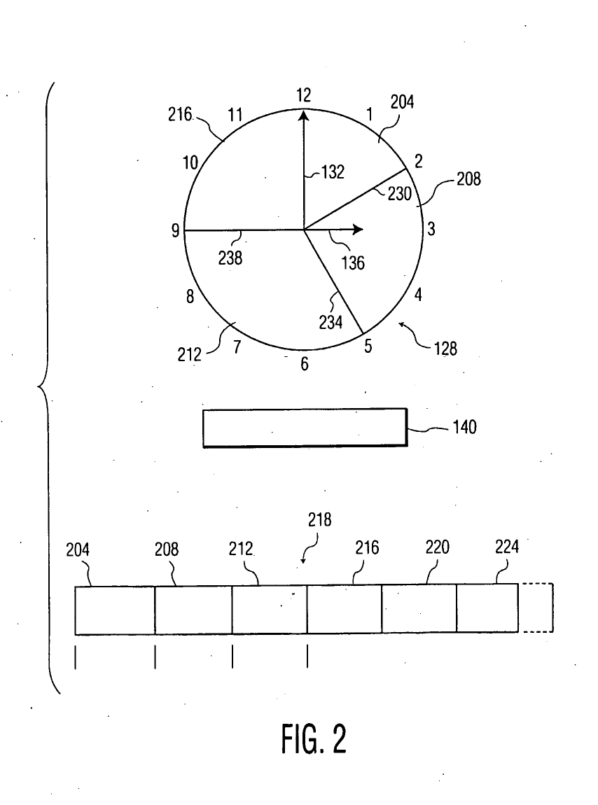

FIG. 2 is a conceptual diagram showing the clock face in more detail, and demonstrating the correspondence between the contents of a memory area and the displayed sectors of the clock face, in accordance with the present invention;

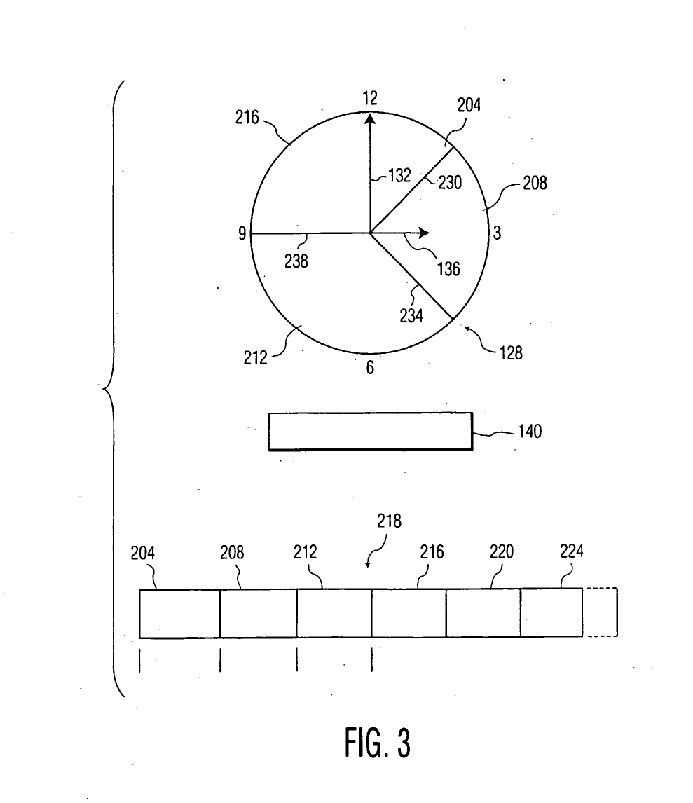

FIG. 3 is a diagram of the clock face in FIG. 2 one minute later, without any intervening navigation, in accordance with the present invention;

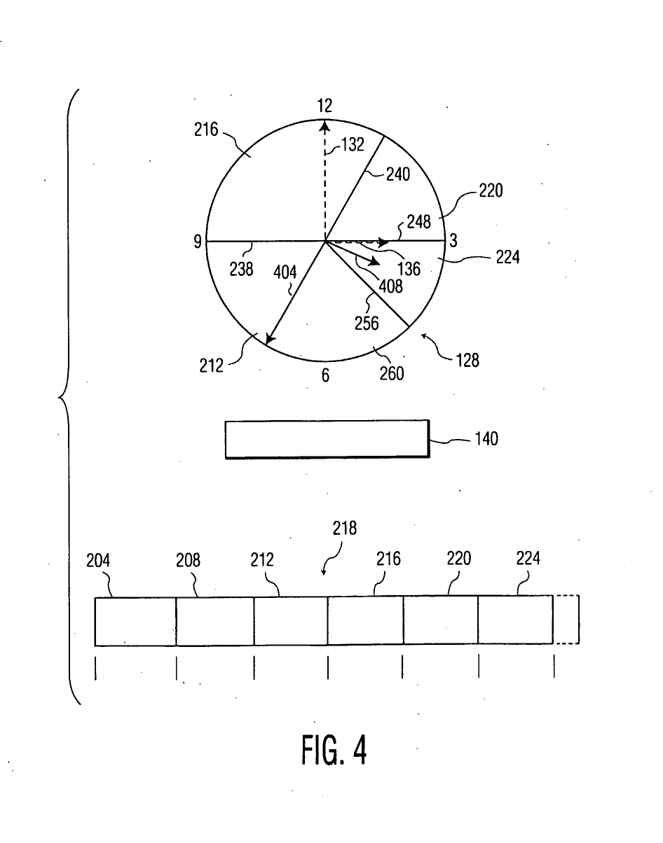

FIG. 4 is a diagram of the clock face in FIG. 3 a few seconds later, after navigation, in accordance with the present invention; and

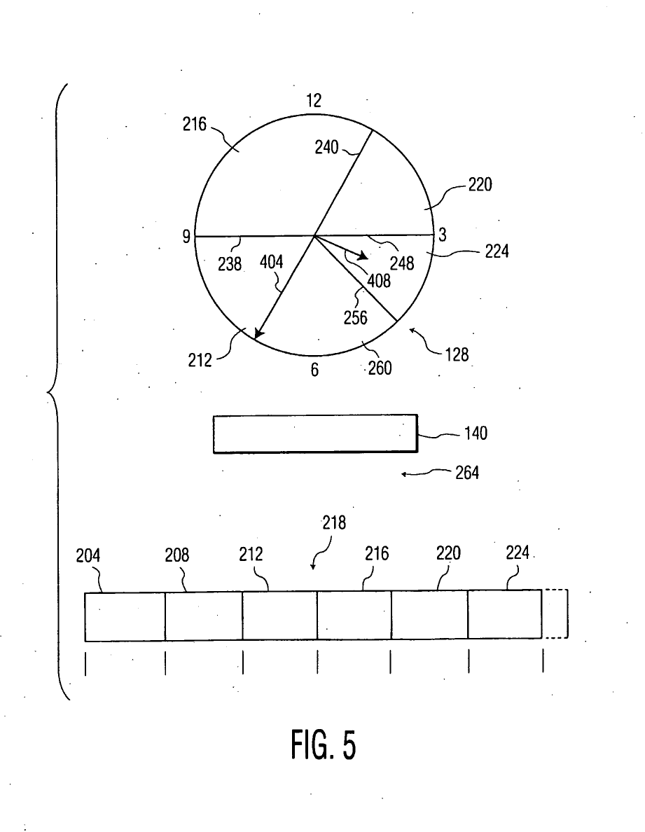

FIG. 5 is a diagram of the clock face of FIG. 4 with an alternative means by which to convey the current time.

The clock-based user interface for an HDD PVR, or PVR with flash memory, in accordance with the present invention enjoys a reduced screen-area footprint. This reduction allows for a minimally obtrusive on-screen presence, and gives rise to potential applications in portable recorders equipped with a small display and mini HDD- or flash memory-based devices such as personal digital assistants (PDAs), video MPEG players and laptops.

FIG. 1 shows, by means of illustrative and non-limitative example, the present user interface implemented at the bottom of a high-definition television screen. A playback system 100 with enhanced user interface, in accordance with the present invention, includes a television 104, a television control unit 108, a recorder 112 connected to the control unit, and a remote control 116.

The television includes a screen 120 that is displaying a scene 124 currently being played back, a clock face 128, a minute hand 132 and hour hand 136, and an accompanying screen field 140.

The recorder 112 contains a processor 141, and a memory 142. The memory 142 includes non-volatile memory, such as that of an HDD or flash card, for saving recordings of audio and/or video in the form of play lists. The memory 142 may also include in the HDD, or in separate storage, a time-shift buffer for receiving programming incoming to the system 100. The memory 142 further includes control such as an operating system and application programs.

Included on the remote control 116 are various controls or buttons for navigating and editing a play list. Among these controls are a forward button 144, a rewind button 148, a skip-forward button 152, a skip-backward button 156, a navigation-speed button 160, an add button 164, a delete button 168, an up-scroll button 172 and a down-scroll button 176. Any of the above buttons may be multi-functional. Thus, for example, the forward and reverse buttons 144 and 148 may serve as navigation buttons during an editing mode, as discussed in more detail further below. It is also clear, from the description below, that the embodiment of the remote control shown in FIG. 2 is non-limiting, and merely an example of one possible implementation.

FIG. 2 shows an example of the displayed clock face 128 in more detail. The present time is assumed to be 3:00 P.M. or “15:00,” as indicated by the positions of the clock hands 132 and 136. The clock face 128 has been sectorized into future time intervals 204, 208, 212, and 216. This sectorization does not limit the possible shapes of the clock face, which may be, for example, square-shaped.

It is further assumed, for purposes of illustration, that the user has selected a particular play list for playback and has commanded display of information about the selected play list. The selection and command may have been carried out through controls on the remote control 116 (those shown or others not shown), or through any other known and suitable means.

The item of the play list that is currently being played back, e.g., at 15:00, is “MTV: STING'S LATEST VIDEO.” The title of the recording currently being played back is always displayed in the field 140. The STING recording corresponds to the first sector, labeled “TITLE 1” 204. The label “TITLE 1” is not displayed and shown in FIG. 2 merely for illustrative purposes. A coloring of the sectors is also possible. The coloring may be according to channel, genre, music style, etc. The numbers surrounding the clock face 128 may or may not be present on the actual display, but are shown here in FIG. 2 for explanatory purposes.

If the play list has just been selected for playback, this video by STING is the first item on the play list. Otherwise, if play back has begun some time ago, the STING video may be a subsequent item on the play list. As shown on the clock face 128, the STING video 204 is scheduled to end at 15:10, at which time the next item on the play list is scheduled to begin playback.

This next item on the play list is “TITLE 2” 208, which runs until 15:25. Next is “TITLE 3” 212 which runs until 15:45, and the next item is “TITLE 4” 216.

The items on the play list are also shown in FIG. 2, in the order in which they reside in an area 218 of memory 142. Here, it is assumed that TITLE 1 204 is the first recording, TITLE 2 is the second recording, etc. Consistent with the clock face 128, the length of the recording is shown below the respective item in memory area 218. This area 218 of memory 142, and its annotations, are preferably not displayed on the television screen 120, and appear in FIG. 2 merely for explanatory purposes. Thus, the size of the user interface display is kept small. The current sectors of the clock face 128 are in one-to-one correspondence with respective items in the area 218 of memory 142, although the recordings subsequent to TITLE 4 216, e.g., TITLE 5 220, TITLE 6 224, etc., are not displayed on the clock face 128. The clock face 128 can show no more than an hour into the future. In this regard, although the clock face 128 indicates that TITLE 4 216 is scheduled to start at 15:45, the TITLE 1 204 sector conceals the endpoint of TITLE 4. Accordingly, judging from the clock face 128 as currently displayed, it cannot be determined when TITLE 4 216 is scheduled to end. This fact is reflected in the lack of specified time duration below the respective item in memory area 218. However, as explained in more detail below, the area 218 can be fully navigated in a manner that correspondingly updates the clock face 128. The display of merely an hour at a time therefore affords the advantage of compact presentation and, yet, does not limit ready access to information.

In addition to the clock hands 132 and 136, also appearing on the clock face 128 are pie-slice radii 230, 234, and 238. The latter always appear in pairs, each pair defining a pie slice, each pie slice representing a sector that fully falls within an hour into the future. In FIG. 2, only two pie slices exist. They are TITLE 2 and TITLE 3 sectors 208 and 212. As to TITLE 1 204, its scheduled end time is 15:10, but its start time is in the past. The TITLE 1 sector is thus not represented by a pie slice. As to TITLE 4 216, its scheduled start time, as discussed above is 15:45, but its scheduled end time is later than 16:00. Thus, TITLE 4 is likewise not represented by a pie slice.

FIG. 3 shows an example of the clock face 128 of FIG. 2 one minute later, at 15:01, without any navigating during the intervening minute. The hands 132 and 136 have advanced by rotating clockwise, thereby increasing the angular range of the TITLE 4 sector 216 and correspondingly decreasing the angular range of the TITLE 1 sector 204. Updating of the clock face occurs continuously with the passage of time, at least once per minute. Despite the increase in angular range for sector 216, there is still no indication on the clock face 128 as to when TITLE 4 is scheduled to end. Accordingly, this sector still does not have a pie slice. As time passes, the advance of the clock hand 132 will eventually uncover for display a pie slice radius, at which point the play back of TITLE 4 ends and the position of the clock hands 132 and 134 marks that end time. Preferably, the end time of one item in the play list corresponds to the start time of the next item, if any. As seen from the area 218 of memory 142, the next item is TITLE 5 220. From the standpoint of sectorizing as it is updated over time, the clock face 128 is sectorized into time intervals that correspond one-to-one with the recordings in the area 218 of memory 142.

FIG. 4 illustrates one example of the clock face of FIG. 3 if the user navigates forward in the memory area 218. Once navigation forward or backward begins, the clock hands 132 and 136 marking the present time become dotted. Emanating from these hands 132 and 136, for rotation. forward or backward, are solid navigation hands 40 and, 408. The latter show that the time navigated to is 15:35. Both pairs of hands will exist until the user navigates back to the present time or until the present time advances to coincide with the navigation time, at which point the navigation hands 404 and 408 overwrite the dotted hands 132 and 136.

Navigation forward to 15:35 has revealed, for display, the pie slice radius 240, which marks the time 16:05 at which transition is scheduled to occur between TITLE 4 216 and TITLE 5 220. Similarly, pie slice radius 248 marks the 16:15 transition between TITLE 5 220 and TITLE 6 224, and pie slice radius 256 marks the 16:25 transition between TITLE 6 224 and TITLE 7 260. The latter sector shows no pie slice, since merely one radius of the pair, e.g., radius 256, is displayed. Accordingly, it is unknown, from the clock face 128, when TITLE 7 260 is scheduled to end. Analogously, it is unknown, from the clock face 128, when TITLE 3 212 began, although we know from FIG. 3 that TITLE 3 212 began at 15:25. The accompanying field 140 shows that TITLE 3 is the short film “STATUS QUO” whose duration is twenty (20) minutes. Recording items whose duration is known from the clock face 128 are correspondingly annotated with respect to their corresponding sections in the memory area 218, as seen from the bottom of FIG. 4. As mentioned above, the appearance of the memory area 218, and its annotations, is preferably not intended for display, and is shown in FIG. 4 merely for illustrative purposes.

Navigation forward, as demonstrated in FIG. 4, may be accomplished by the user holding down the forward button 144. As long as the button 144 is held down, the navigation hands 404 and 408 wind forward at respective, predetermined angular velocities. These velocities may have default values that are adjustable by the user actuating the navigation-speed button 160 to slow down or speed up the hand rotations. The reverse button 148 works analogously to navigate back to an earlier time in the play list at the selected velocities of rotation. Alternatively, rather than smooth or continuous rotation, navigation may be made by discrete jumps. Thus, pressing the skip-forward or skip-backward buttons 152 and 156 causes the navigation hands 404 and 408 to immediately revolve forward or backward to the next pie slice radius in the forward or backward direction, as appropriate. The field 140, in this mode of operation, displays the name of the recording for the temporally earliest pie slice displayed.

Pressing the delete button 168 deletes the recording currently indicated in the field 140. If any recordings are subsequent to the recording deleted, the clock face 128 is refreshed to immediately move the subsequent sectors forward to fill the gap. The area of memory may be merely re-referenced by means of pointers. Alternatively, as in the case of flash memory, for example, the memory for the deleted recording may be cleared immediately. Thus, subsequent recordings can be immediately shifted to fill the gap. Play lists such as the memory area 218 also may be implemented as shift buffers of an HDD or flash chip. It is also possible to leave gaps in a play list, such as when an item has been deleted.

Pressing the add button 164 brings up on the display 120 a navigation box that windows into the table of contents. The latter includes lists of recordings in memory 142. Using any one or more of the buttons 144, 148, 172, and 176 in this mode of operation, the user may select the recording to be added to the current play list.

During navigation and editing, the playback preferably continues, seamlessly following the order of items on the play list.

Once editing is finished, the user may press the navigation-speed button 160 which functions now as a RESUME button to re-display the clock face 128 with the navigation hands 404 and 408 showing the present time, and with the clock face revealing merely an hour into the future.

FIG. 5 represents an alternative to showing two pairs of clock hands during navigation. The clock face of FIG. 4 is shown without the dotted clock hands 132 and 136 (the)to? track the present time. Instead, a present-time field 264 appears below the accompanying field 140. Although shown in this position, the present-time field 264 on the right or left side of the clock face 128, or above the clock face. As soon as the current time progresses to a point where it is identical to the navigated-to time, or as soon as the navigated-to time matches the current time, a single pair of clock hands is all that is needed. Therefore, the present-time field 264 disappears from the screen 120, and does not reappear until the two times differ once again.

In either implementation, i.e., with or without the second pair of clock hands, it is possible to display, next to the clock face 128, a table with the play list items and their corresponding start/end times. This allows the user to see immediately what falls in the current hour of the play list. The table preferably covers more than one hour of information, i.e., a little more in the past and a little more in the future. The table is updated in correspondence to the movement of clock hands 132 and 136, or the movement of navigation hands 404 and 408 during navigation.

With regard to the coloring of the displayed sectors, the background color of the display may be used to indicate that a sector is blank. This may occur due to deletion of a recording or due to the end of the play list being less than an hour away. When the current time, or the navigation time during navigation, comes within a blank sector, the field 140 is likewise blank.

Also with regard to coloring, the present invention need not be implemented with pie slice radii, but may rely instead on the different coloring and/or hatching of adjacent sectors.

In another embodiment, the forward and reverse buttons 144 and 148 need not be held down, but instead merely pressed briefly to actuate the revolving of the navigation hands 404 and 408 which continues after the button is released. In this case, the add or delete buttons 164 and 168 may be pressed at the moment when the addition or deletion is to be made.

In an alternative embodiment, the navigation-speed button 160 is eliminated. Instead, the speed is dictated by how long the user keeps the forward or rewind buttons 144 and 148 pressed down on a long button press. During a long button press the speed selection progresses in cyclical order, e.g., 2, 4, 8, 16 . . . , while the button remains pressed. Invoking forward or reverse buttons merely at the current speed, by contrast, is accomplished by a short button press of the respective buttons 144 and 148. As an additional button, a stop button may be provided to stop the rewinding or forwarding.

As yet another alternative, the user interface may include a control to allow the user to “revolve” the play list forward or backward, so that playback is immediately interrupted and shifted to another point in the playback. The clock face 128 would be immediately updated accordingly. Preferably, the “revolving” of the play list is implemented by revolving the clock hands 132 and 136 instead and correspondingly updating the sectors displayed. Although navigation is preferably at the sector level in the present invention, this is not a requirement. Thus, for example, the resumption of the interrupted playback may be made to occur at a desired point within the selected recording, by navigating to that point and appropriately invoking the user control.

Although the field 140 is used to indicate the recording currently being played back, the present invention is not limited in this manner. The present invention may, for instance, additionally or alternatively include a speech synthesizer that announces program titles during navigation.

Notably, in accordance with the present invention, navigation may function merely to identify the current time interval to the user, thereby serving, for example, as a compact user interface that allows the user to scan a memory device.

The clock-based interface makes it easier for the user to immediately realize the length of a recording that is upcoming within the next hour.

As mentioned above, clock-based navigation and editing by means of the user interface of the present invention reduces the screen footprint. The reduced footprint is especially desirable to meet the small form factor of modern, mobile, and particularly hand-held devices. This is accomplished by spiraling the ordinal arrangement of recordings in memory into a layered, symmetrical configuration affording display of merely an hour's worth of programming at a time. Moreover, the intuitive notion of revolving clock hands is leveraged to provide an easily-understandable user navigation/editing tool.

While there have been shown and described what are considered to be preferred embodiments of the invention, it will be, of course, understood that various modifications and changes in form or detail could be readily made without departing from the spirit of the invention. It is therefore intended that the invention not be limited to the exact forms described and illustrated, but should be constructed to cover all modifications that may fall within the scope of the appended claims.

What is claimed is:

1. An apparatus for navigating an area (218) of memory (142), said apparatus comprising:
a clock face (128) sectorized into time intervals;
a user input device (116); and
a processor (141) configured for, responsive to user input from said device, rotating a clock hand (404) across said face to navigate said area whose contents correspond with the sectors (208).

2. The apparatus of claim 1, wherein the time intervals are intervals of future time (216).

3. The apparatus of claim 2, wherein the processor is configured to maintain, as time passes, sectorization into intervals of future time by updating the sectorization (204, 216).

4. The apparatus of claim 3, wherein the updating is continuous with the passage of time, occurring at least once per minute (204, 216).

5. The apparatus of claim 1, wherein said contents are divided into one-to-one correspondence with said sectors, granularity of the navigating being at the sector level (204, 208).

6. The apparatus of claim 1, wherein said processor is configured for said rotating so as to navigate to a location in said area and, at said location (144, 148, 404, 408), for at least one of adding to, and deleting, contents of said area (164, 168).

7. The apparatus of claim 6, wherein the clock hand is a first clock hand (404), said processor being configured to rotate another clock hand across said face for said navigating (408), in conjunction with the first clock hand, to said location.

8. The apparatus of claim 1, wherein directionality, speed and smoothness of the rotating to navigate are controlled by means of said user input (152, 156, 160).

9. The apparatus of claim 1, wherein, correspondence-wise with said sectors, said area extends over an hour into the future (216).

10. The apparatus of claim 1, further configured to leave behind, upon said rotating to navigate, onto said face a clock hand for indicating a current time (132, 136).

11. The apparatus of claim 1, further configured to annotate, upon said rotating to navigate, said face with a present-time field that is displayed until navigated-to time coincides with a present time (264).

12. An apparatus for navigating an area (218) of memory (142), said apparatus comprising:
a display (120) for displaying a field (140) and a clock face (128) sectorized into time intervals;
a user input device (116); and, a processor (141) configured for, responsive to user input from said device, rotating concentrically with the sectors (208) a clock hand across said face, and for displaying items (260) in said field in correspondence with the sector of said sectors that currently contains said hand.

13. The apparatus of claim 12, wherein the time intervals are intervals of future time (216).

14. A method for navigating an area (218) of memory (142), said method comprising:
sectorizing a clock face (128) into time intervals; and
responsive to user input from a user input device (116), rotating a clock hand (404) across said face to navigate said area whose contents correspond with the sectors.

15. The method of claim 14, wherein the time intervals are intervals of future time (216).

16. The method of claim 15, further including updating, as time passes, to maintain the sectorizing into intervals of future time (204, 216).

17. The method of claim 16, wherein the updating is continuous with the passage of time, occurring at least once per minute (204, 216).

18. The method of claim 14, wherein said sectorizing divides said contents into one-to-one correspondence with said sectors, granularity of the navigating being at the sector level (204, 208).

19. The method of claim 14, wherein said rotating includes navigating to a location in said area and, at said location (144, 148, 404, 408), at least one of adding to, and deleting, contents of said area (164, 168).

20. A method for navigating an area of memory, said method comprising:
sectorizing a clock face (128) into intervals;
providing an associated field (140);
responsive to user input (116), rotating, concentrically with the sectors, a clock hand (404) across said face; and
displaying items in said field in correspondence with the sector (260) of said sectors that currently contains said hand.

21. The method of claim 20, wherein the time intervals are intervals of future time (216).

22. A computer-program product having a medium (142) readable by a computer (141), said medium containing a program executable for navigating an area of memory, said program comprising:
instructions for sectorizing a clock face (128) into time intervals; and
instructions for, responsive to user input from a user input device (116), rotating a clock hand (404) across said face to navigate said area whose contents correspond with the sectors.

23. The product of claim 22, wherein the time intervals are intervals of future time (216).

24. The product of claim 22, wherein the instructions for rotating include instructions for navigating said area (218) to at least one of add to, and delete, said contents (164, 168).
